(19) United States
(12) Patent Application Publication
(10) Pub. No.: US 2020/0019949 A1
(43) Pub. Date: Jan. 16, 2020

(54) AUTOMATIC CHECKOUT SYSTEM

(71) Applicants: Freedom Shopping, Inc., Statesville, NC (US); Sunbelt Rentals, Inc., Fort Mill, SC (US)

(72) Inventors: Rob Simmons, Statesville, NC (US); Adam Ramsey, Statesville, NC (US); Marccus Rubenstein, Raleigh, NC (US)

(21) Appl. No.: 16/489,301

(22) PCT Filed: Mar. 6, 2018
(86) PCT No.: PCT/US2018/021171

§ 371 Date: Aug. 27, 2019

Related U.S. Application Data
(60) Provisional application No. 62/467,727, filed on Mar. 6, 2017.

(51) Int. Cl. G06Q 20/20; H04W 4/35; G06K 9/00; G06Q 10/08; G08B 13/24

(52) U.S. Cl. CPC G06Q 20/208; G06Q 20/204; G08B 13/246; G06K 9/00771; G06Q 10/087; H04W 4/35

(57) ABSTRACT

Methods, systems, and apparatus for an automatic checkout system. The system includes a gateway having one or more sensors configured to detect when a patron and the item are within a sensing area and when the patron and the item have left the sensing area, and one or more sensors configured to detect a patron identification associated with the patron and an item identification associated with the item when the patron and the item are within the sensing area. The system also includes an inventory management unit connected to the gateway. The inventory management unit is configured to identify the patron based on the patron identification, identify the item based on the item identification, and update a database when the patron and the item have left the sensing area to indicate that the patron has checked out the item.

### CROSS REFERENCE TO RELATED APPLICATIONS

This application claims the benefit and priority of U.S. Provisional Application Ser. No. 62/467,727, filed Mar. 6, 2017, entitled “Automatic Checkout System,” the contents of which are herein incorporated by reference in its entirety.

### BACKGROUND

### 1. Field

This specification relates to a system and a method for automatically checking out items from a secure location.

### 2. Description of the Related Art

Conventional processes for purchasing, renting, or provisioning items may include time-consuming steps and interactions between a patron and a vendor, and may have the potential for human error and inaccuracy. For example, when a patron wishes to purchase various items, an employee of the vendor may scan each item until all items are accounted for, and the patron may then pay for the total cost of all the items. Some self-checkout systems exist where the patron him/herself scans each item and then pays for the total cost of all the items. However, such systems may slow down patrons wishing to purchase items quickly.

### SUMMARY

An automatic checkout system is described herein. The system includes a gateway defining a sensing area and separating an outside area and an inside area for storing the item. The gateway includes one or more presence sensors configured to detect when a patron and the item have entered the sensing area from the inside area, and when the patron and the item have left the sensing area to the outside area. The gateway also includes one or more identification sensors configured to detect a patron identification associated with the patron and an item identification associated with the item when the patron and the item are within the sensing area. The system includes an inventory management unit connected to the gateway. The inventory management unit is configured to identify the patron based on the patron identification, identify the item based on the item identification, and update a database when the patron and the item have left the sensing area to the outside area to indicate that the patron has checked out the item.

An automatic check-in system is described herein. The system includes a gateway defining a sensing area and separating an outside area and an inside area for storing the item. The gateway includes one or more presence sensors configured to detect when a patron and the item have entered the sensing area from the outside area, and when the patron and the item have left the sensing area to the inside area. The gateway also includes one or more sensors configured to detect a patron identification associated with the patron and an item identification associated with the item when the patron and the item are within the sensing area. The system includes an inventory management unit connected to the gateway. The inventory management system is configured to identify the patron based on the patron identification, identify the item based on the item identification, and update a database when the patron and the item have left the sensing area to the inside area to indicate that the patron has checked in the item.

A method for managing a status of an item using a gateway defining a sensing area and separating an outside area and an inside area for storing the item is disclosed. The method includes detecting, by one or more presence sensors, when a patron and the item have entered the sensing area from the inside area. The method also includes detecting, by one or more identification sensors, a patron identification associated with the patron and an item identification associated with the item when the patron and the item are within the sensing area. The method also includes identifying, by an inventory management unit, the patron based on the patron identification. The method also includes identifying, by the inventory management unit, the item based on the item identification. The method also includes detecting, by the one or more presence sensors, when the patron and the item have left the sensing area to the outside area. The method also includes updating, by the inventory management unit, a database when the patron and the item have left the sensing area to the outside area to indicate that the patron has checked out the item.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 is an illustration of an exemplary implementation of the automatic checkout system, according to embodiments of the invention.

FIGS. 2A-2B are illustrations of the gateway of the automatic checkout system, according to embodiments of the invention.

FIGS. 3A-3C are illustrations of an individual on foot interacting with the automatic checkout system, according to embodiments of the invention.

FIGS. 4A-4C are illustrations of an individual in a vehicle interacting with the automatic check-out system, according to embodiments of the invention.

FIG. 5 is a flowchart of a check out process, according to embodiments of the invention.

FIG. 6 is a flowchart of a check-in process, according to embodiments of the invention.

FIG. 7 is a flowchart of a purchasing process, according to embodiments of the invention.

### DETAILED DESCRIPTION

Disclosed herein are systems, apparatuses, and methods for an automatic checkout system. The automatic checkout system is capable of allowing a person to walk or drive through a checkout station continuously while checking items out from a secured vending area, with an option to confirm, edit, or cancel the checkout or simply allow checkout or allocation by continuing through the checkout area. Additionally, the system may be capable of allowing a person to traverse through the station while checking in items to a secured vending area.

The system includes a drive-thru structure (or vehicle structure) for vehicles to pass through, and/or a walk-thru structure (or pedestrian structure) for individuals to pass though. In some embodiments, the drive-thru structure is a structured awning that has sensors, such as RFID antennas (or readers) mounted at the top of it for reading RFID tags, as well as cameras that may be used for capturing images of the items/assets and the patrons involved in a transaction. Similarly, the walk-thru structure may be a tunnel that also contains sensors, such as RFID antennas mounted on a ceiling for reading RFID tags, as well as cameras that may be used for capturing images of the items/assets and the patrons involved in a transaction and/or for motion detection.

While RFID is discussed in the embodiments herein, any non-line-of-sight sensing technology (e.g., Bluetooth, Wi-Fi, NFC) may be used to detect tags attached to the items, patrons, or equipment, using sensors. The drive-thru structure may include awnings having multiple pillars and being attached to the walk-thru structure. The pillars of the awning may have triggering sensors mounted so that when a pedestrian, forklift, utility task vehicle (UTV), all-terrain vehicle (ATV), heavy equipment, or other vehicle passes through it, a session begins.

There may be multiple triggering sensors spaced away from each other, with one proximal to the outside of the secured area and another proximal to the inside of the secured area, such that an order of activation of the triggering sensors may be used to determine whether a patron is entering the secured vending area or exiting the secured vending area. For example, when there are two sensors (e.g., photo eyes or cameras) for detecting the presence of a patron in the checkout area, an outer sensor may be positioned closer to the outside of the secured area, and an inner sensor may be positioned closer to the inside of the secured area, such that a patron entering the secured area triggers the outer sensor first, and then the inner sensor, and a patron leaving the secured area triggers the inner sensor first, and then the outer sensor. Having these multiple sensors allows the automatic checkout system to determine whether a patron is entering or exiting the secured area.

The automatic checkout system described herein may be used in any number of contexts, such as equipment rental, retail, manufacturing, or inventory management, for example. The system described herein may be used to keep track of rental items being checked in and checked out without the logistic requirements of conventional systems, whereby the patron manually scans an item to be rented and manually provides identification for renting out the item. The system described herein may also be used in a retail space, for automatically assigning a price of the associated item to an account of the patron for automated payment when the patron leaves the vending space, such that a conventional payment routine of scanning the items and receiving a payment from the patron may not be necessary. The system described herein may also be used in the manufacturing and distribution space, for managing an inventory of items. When items are loaded onto vehicles or other transport mechanisms for distribution, the system described herein may be used to verify that the correct items were sent to the correct vehicles, and that the correct items are received from the correct vehicles.

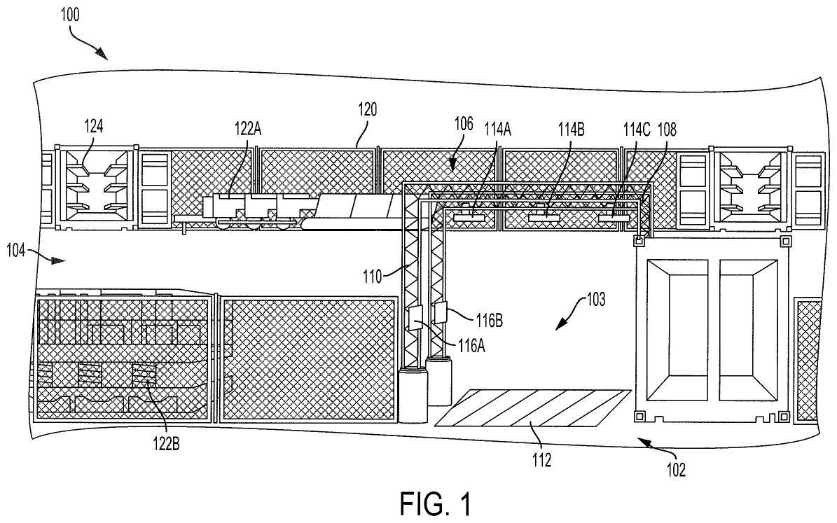

FIG. 1 is an illustration of an exemplary implementation of the automatic checkout system, according to embodiments of the invention. The automatic checkout system may be used with a vending area (or secured area) 104 for securely storing and managing an inventory of equipment 122 or items 124. The vending area 104 may be defined by a border structure 120, such as a fence or wall. In some embodiments, the vending area may be an enclosed space, such as a warehouse or a room.

The equipment 122 may include machinery 122A, such as a lift for lifting individuals or objects, an air compressor, an air handler, a chiller, a compactor, a generator, a load bank, or a ventilation unit, for example. The equipment 122 may also include vehicles 122B, such as forklifts, sweeping machines, backhoes, excavators, tractors, trenchers, dozers, compactors, rollers, all-terrain vehicles, cars, or trailers, for example. The items 124 may include power tools, pumps, air compressors, scaffolding, or ladders, for example. While items 124 have been distinguished from equipment 122 herein, there may be no distinction between the objects that are in one category or the other in operation of the system, and some objects may fall in both categories. “Items” and “equipment” may be used herein interchangeably to refer to the object to be checked out, checked in, tracked, rented, or purchased by the patron.

The system 100 includes a gateway (or tunnel, entrance, doorway, drive-thru, access, or opening) 106. The gateway 106 includes at least one vertical structure 110 and at least one horizontal structure 108. The gateway 106 could include any combination of vertical structures (e.g., posts, beams, rods, walls) and horizontal structures (e.g., posts, beams, rods, walls, roofs, floors) to form the gateway 106. The gateway 106 defines a sensing area 112. The sensing area 112, while illustrated in FIG. 1 as a two dimensional area on the ground, may be a three dimensional space defined by the gateway 106. The sensing area 112 is where various tags or identifications may be detected.

The gateway 106 also includes one or more identification sensors 114A-114C. In some embodiments, the identification sensors 114 are any non-line-of-sight sensor, such as an RFID antenna, a Bluetooth antenna, a Wi-Fi antenna, or any other sensor not requiring direct line of sight with a corresponding tag or identification. For example, the identification sensors 114 may be RFID antennas capable of detecting an RFID tag, even if there is an object between the RFID tag and the identification sensor 114.

In some embodiments, the identification sensors 114 are image sensors that are capable of detecting image data. For example, the identification sensors 114 may be a series of high definition cameras configured to detect image data, and the image data may be used to identify objects or individuals based on an analysis of the image data. For example, each object or individual may have distinguishing characteristics that may be cross-referenced with a database of objects and individuals to identify the object or individual. In some embodiments, each object or individual may have a unique tag, sticker, or other identifier displayed on an exterior surface, and the image data capturing the tag or sticker may be used to identify the object or individual.

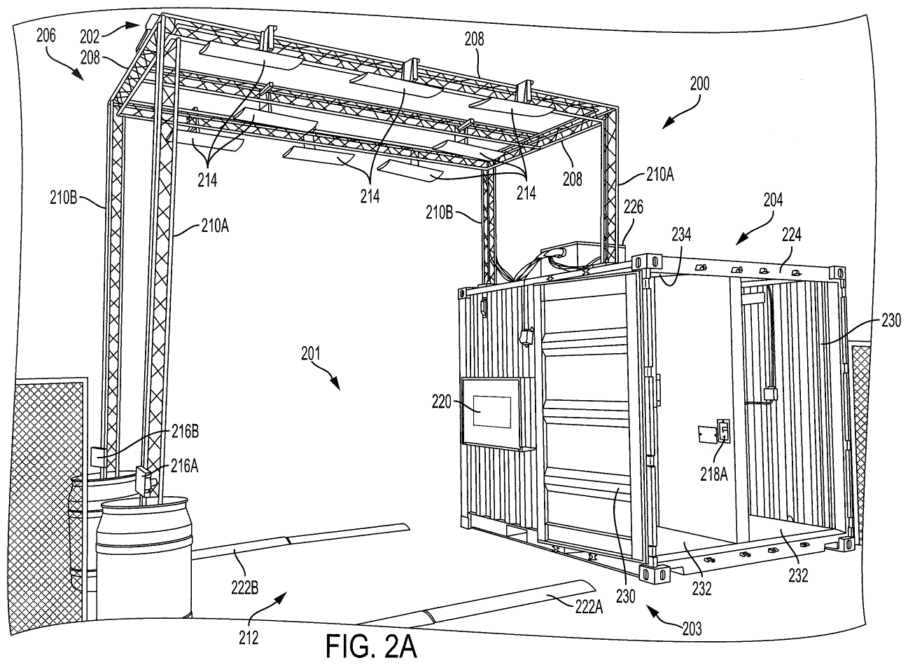

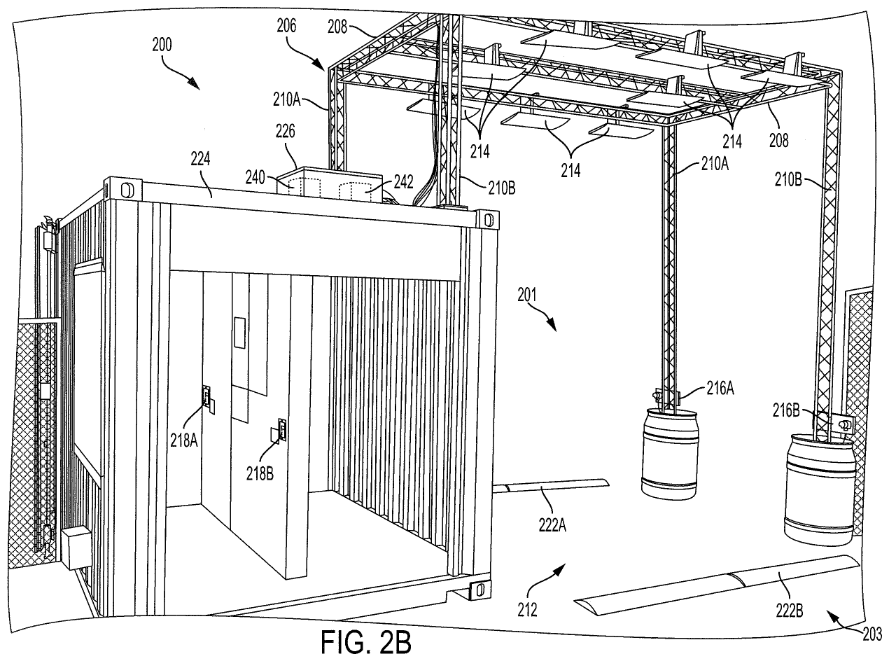

The gateway 106 also includes one or more presence sensors 116A-116B. The presence sensors 116 are configured to detect the presence of an individual or an object in the sensing area 112. The presence sensors 116 may be a motion detection sensor, camera, heat sensor, laser sensor, photo eye, RADAR, LIDAR, or any other sensor configured to detect motion or the presence of an object. There may be an outer presence sensor 116A located closer to the outside 102 of the vending area 104. There may also be an inner presence sensor 116B located closer to the inside 103 of the vending area 104. In some embodiments, presence sensors 116 may include motion detection cameras mounted on the gateway 106, for example (not shown) on vertical structure 110 and/or horizontal structure 108 and on pedestrian structure 204 of FIG. 2.

When the presence sensors 116 are triggered, the identification sensors 114 may be activated, and the identification sensors 114 may detect the presence of an individual or an object within the sensing area 112. The interactions of the presence sensors 116, identification sensors 114, individuals or objects, and the sensing area 112 is further described below.

The gateway 106 may be appropriately sized for a vehicle or a pedestrian to pass through the gateway 106. As shown in FIG. 1, the gateway 106 may include a larger structure for a vehicle to pass through, as well as a smaller structure for individuals on foot to pass through.

FIGS. 2A-2B are illustrations of the system, according to embodiments of the invention. FIG. 2A shows a front perspective view of the system 200. That is, the view shown in FIG. 2A is that of an individual on the outside 203 of the secured area, looking into the inside 201 of the secured area. FIG. 2B shows a back perspective view of the system 200. That is, the view shown in FIG. 2B is that of an individual on the inside 201 of the secured area, looking out to the outside 203 of the secured area.

The system 200 includes a gateway 206. The gateway 206 may include a vehicle structure 202 for vehicles to pass through and a pedestrian structure 204 for individuals to pass through on foot.

The vehicle structure 202 may be made of multiple vertical structures 210 and multiple horizontal structures 208. The multiple vertical structures 210 include a front vertical structure (or outer vertical structure) 210A which is closer to the outside 203 of the secured area than the inside 201 of the secured area, and a back vertical structure (or inner vertical structure) 210B which is closer to the inside 201 of the secured area than the outside 203 of the secured area. The horizontal structures 208 are configured to connect the vertical structures 210 together such that the vehicle structure 202 forms a three-dimensional shape.

While the three-dimensional shape shown in FIGS. 2A-2B is a rectangular prism, any configuration of vertical structures and horizontal structures may be used to form any three-dimensional shape. The vertical structures 210 and the horizontal structures 208 may be adjusted in length to accommodate for various situations and configurations. For example, the vertical structures 210 and the horizontal structures 208 may be made of telescoping tubes or extendable tubes or foldable tubes, such that they may be lengthened or shortened to accommodate for various sizes of vehicles or equipment that may pass through the gateway 206. In an example embodiment, when the system 200 is used for a storage area having backhoes and tractors to be driven through the gateway 206, the vertical structures 210 may be taller and the horizontal structures 208 may be wider than when the system 200 is used for a storage area having riding lawnmowers and handheld power tools.

In some embodiments, the system 200 may be a portable system configured to be disassembled, moved, and re-assembled, in order to provide a non-permanent solution for those seeking to temporarily use the automated checkout system disclosed herein.

The area defined by the vertical structures 210 and the horizontal structures 208 of the vehicle structure 202 may be referred to as a sensing area 212. Presence sensors 216 may be attached to the vertical structures 210. For example, the front vertical structure 210A may have a front presence sensor 216A attached to it, and the back vertical structure 210B may have a back presence sensor 216B attached to it. When a patron enters into the sensing area 212 from the outside 203 to the inside 201, the patron triggers the front presence sensor 216A and then the back presence sensor 216B.

When the patron is within the sensing area 212, the identification sensors 214, which are connected to the horizontal structures 208 above the ground, may detect a patron identification on the patron's person, and/or an item identification attached to the item. The identification sensors 214 may be in a non-sensing mode when the presence sensors 216 detects that nobody is within the sensing area 212, and the identification sensors 214 may be in a sensing mode when the presence sensors 216 detects that a person is within the sensing area 212. In this way, the identification sensors 214 may use power in an economical manner.

The identification sensors 214 are shown as being arranged along three rows of horizontal structures 208 and forming a generally circular or square shape. That is, there are three identification sensors 214 along a front row and a back row, and two identification sensors at the left and right end of the middle row between the front row and the back row. This is an example arrangement of the identification sensors 214, and additional identification sensors 214 may be used in other locations and/or the identification sensors 214 may be rearranged to maximize detection capabilities within the sensing area 212.

There may be speed bumps 222A-222B along the front edge and the back edge of the sensing area 212 to slow down vehicles that are within the sensing area 212 to assist the presence sensors 216 and the identification sensors 214 in having sufficient time to detect their respective data.

The system may also include a display 220 showing an identification of the patron (e.g., a photo identification, an ID number associated with the patron, an organization the patron is a member of, or a name of the patron), an identification of the item (e.g., an image of the item, an ID number associated with the item, a name of the owner of the item, or a name of the item), one or more warning alerts, one or more activity alerts or signals, or any other information associated with the system.

The pedestrian structure 204 may be made of a tunnel 224 being open on both ends, and having multiple walls 230. Operationally, the pedestrian structure 204 may be similar to the vehicle structure 202, with the primary difference being that of scale. An individual patron on foot may pass through either the vehicle structure 202 or the pedestrian structure 204, but a vehicle may only pass through the vehicle structure 202. In some embodiments, the tunnel 224 is a metal cargo container or a partial cargo container.

Inside the pedestrian structure 204 may be a pair of presence sensors 218 (a front presence sensor 218A shown in FIGS. 2A and 2B and a back presence sensor 218B shown in FIG. 2B), which has similar functionality to the presence sensors 216 of the vehicle structure 202, described herein. In addition, the pedestrian structure 204 may also have a sensing area 232 similar to sensing area 212, and may have identification sensors 234 similar to identification sensors 214. The sensing area 232 may be entirely within the pedestrian structure 204, and the outer bounds of the sensing area 232 may be defined by the presence sensors 218 within the pedestrian structure 204. As shown in FIG. 2B, the pedestrian structure 204 may have two lanes for patrons to pass through. In some embodiments, one lane is an entrance lane to the secured area and the other lane is an exit lane out from the secured area. In some embodiments, each of the two lanes are bidirectional and capable of discerning those entering from those exiting. In some embodiments, a display may be located within the interior of the pedestrian structure 204.

As shown in FIG. 2B, the system 200 may also include a component storage compartment 226 configured to store one or more components, such as the inventory management unit 240 and the database 242. In some embodiments, the inventory management unit 240 and the database 242 are located in another location in the gateway 206. In some embodiments, the inventory management unit 240 and/or the database 242 are remotely located on a remote server. The inventory management unit 240 may be one or more processors configured to execute instructions stored on a non-transitory memory (e.g., a separate local memory or database 242). The inventory management unit 240 may be a special-purpose machine specifically configured to perform the actions described herein. The inventory management unit 240 may perform these actions in a manner that improves the computing efficiency of the inventory management unit 240 as compared to a conventional computing system.

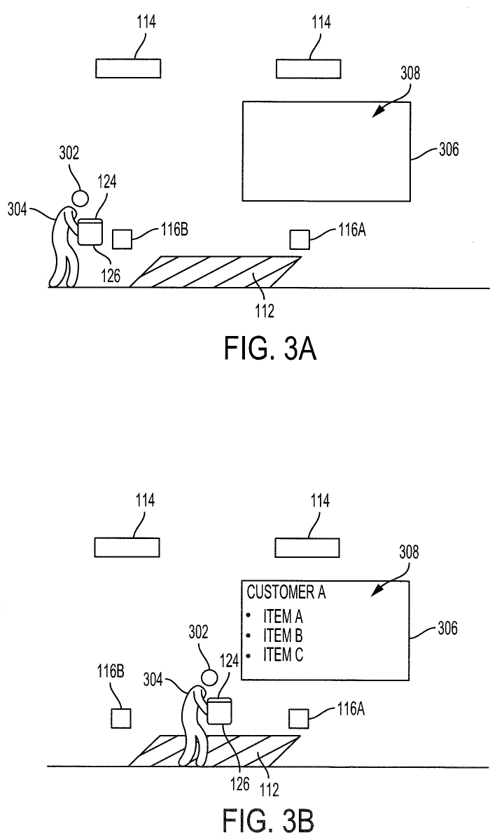

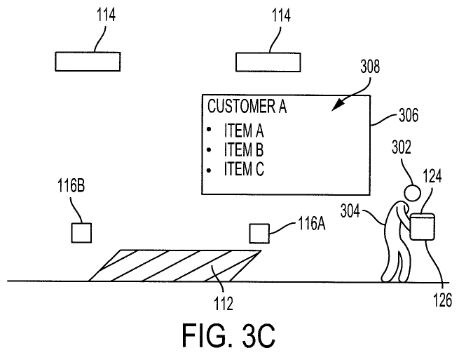

FIGS. 3A-3C are illustrations of an individual on foot interacting with the automatic checkout system, according to embodiments of the invention.

In FIG. 3A, an individual 302 is carrying an item 124 that the individual 302 has obtained from the vending area (e.g., vending area 104). The individual 302 would like to check the item 124 out and use the item 124. For example, the individual 302 is a flooring specialist and would like to check out item 124, which is a saw. Thus, the individual 302 is approaching the system from the inside in order to leave with the item 124.

The individual 302 may have on his/her person a patron identification 304. The patron identification 304 may be a unique electronic product code (EPC) badge associated with an account. The account may be associated with an individual and/or an organization, and the system may be capable of managing transactions for multiple individuals and organizations.

The item 124 may also have an item identification 126. The item identification 126 may be a unique EPC that may link to a serial number or SKU number, if applicable. The patron identification 304 and the item identification 126 may be tags configured to be detected by the identification sensors 114. In FIG. 3A, the individual 302 has not yet triggered the inner presence sensor 116B. Therefore, the identification sensors 114 may not yet be activated.

In FIG. 3B, the individual 302 triggers the inner presence sensor 116B (e.g., by breaking and unbreaking a triggering emission from the sensor) and the identification sensors 114 are activated. The individual 302 is now within the sensing area 112, and the identification sensors 114 are activated. The identification sensors 114 detect the patron identification 304 and the item identification 126 within the sensing area 112, The system locates information associated with the individual 302 and the item 124. At this point, the item 124 may be added to an item list (or checkout list, or transaction list), but may not yet be assigned as being checked out to the individual 302.

In FIG. 3C, the individual 302 triggers the outer presence sensor 116A and exits the sensing area 112. At this point, the system may assign the item 124 as being checked out to the individual 302, and a record may be created in a system database.

In some embodiments, photo(s) from an assigned camera(s) opposite of the sensor are taken so that a visual identification record can be made of the patron.

As shown in FIGS. 3A-3C, a checkout screen 306 may be provided. The checkout screen 306 may display checkout information 308 to show the individual 302 what he/she is checking out. The checkout screen 306 may be a display adjacent to the sensing area 112 or may be a display on a mobile device associated with the individual 302. The checkout information 308 may also be sent to third parties associated with the individual 302, such as a company the individual 302 works for. The checkout information 308 may be displayed while the individual 302 and the item 124 are in the sensing area 112 and/or after the individual 302 and the item 124 have exited the sensing area 112.

In some embodiments, the system may verify whether the individual 302 checking out the item 124 is properly qualified or certified to use the item 124. The system database may store certification information associated with the individual 302, and when the individual 302 attempts to check out an item 124 that he/she is not certified to use, the system may create an alert. An administrator may request additional information from the individual 302 based on the alert.

The process shown in FIGS. 3A-3C may, at a later time, be performed in reverse, with the individual 302 returning the previously checked-out item 124, such as a rented item. During a check-in procedure, when the individual 302 and the item 124 are in the sensing area 112, the system may access the system database to determine whether the individual 302 has checked out item 124. In some embodiments, the individual 302 may return the item 124 on behalf of a coworker, and the system may recognize the check-in if the individual 302 and the coworker (who is on record as checking out the item 124) are associated in the system database. Two individuals may be associated in the system database if they both are recorded as working for the same company, for example.

In some situations, when an error occurs during check-in or checkout of an item, a duplicate transaction may occur. For example, when an error occurs during the checkout of an item by Patron B, in the database of the system, the item may be identified as still being checked out to Patron A. Accordingly, when the item is brought back to be checked in by Patron B, the system may expect Patron A, and a conflict may be generated. The conflict may be resolved by creating a correction record in the database indicating that the item was checked in by Patron B, and also constructively checked in by Patron A at an earlier time, preventing duplication and resolving items having an incorrect status.

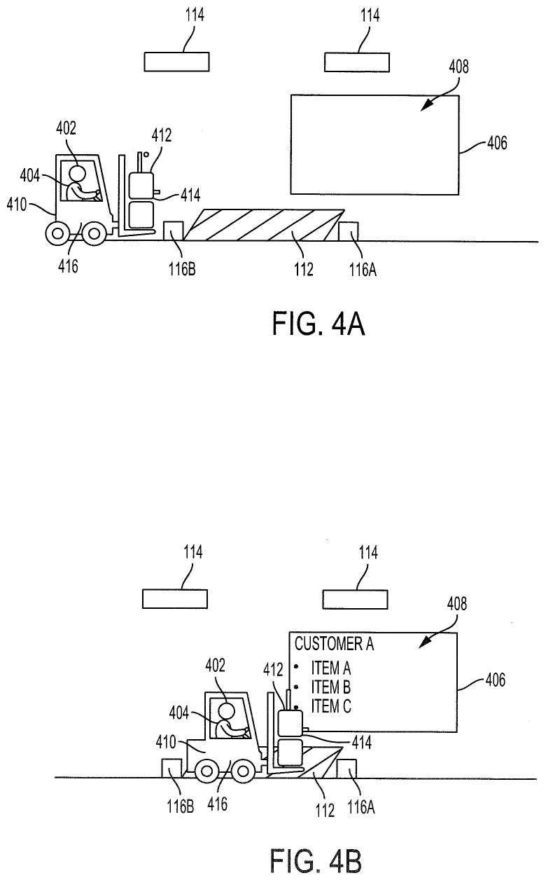

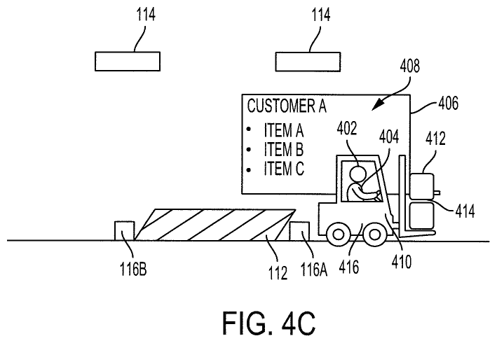

FIGS. 4A-4C are illustrations of an individual in a vehicle interacting with the automatic check-out system, according to embodiments of the invention.

In FIG. 4A, an individual 402 is operating a vehicle 410. The vehicle 410 may be the individual's own vehicle or may be equipment stored within the vending area (e.g., vending area 104) to be rented by the individual 402. The vehicle 410 is carrying an item 412 that the individual 402 has obtained from the vending area. The individual 402 would like to check the item 412 out and use the item 412 as well as the vehicle 410. For example, the individual 402 is a pavement specialist and would like to check out item 412, which is a mechanical tamper. The individual 402 also needs to move heavy objects, so the individual 402 would also like to check out the vehicle 410, which is a forklift. Thus, the individual 402 is approaching the system from the inside in order to leave with the item 412 and the vehicle 410. The individual 402 may have on his/her person a patron identification 404. The item 412 may also have an item identification 414. The vehicle 410 may have a vehicle identification 416. The patron identification 404, the item identification 414, and the vehicle identification 416 may be tags configured to be detected by the identification sensors 114. In FIG. 4A, the individual 402 and the vehicle 410 have not yet triggered the inner presence sensor 116B. Therefore, the identification sensors 114 may not yet be activated.

In FIG. 4B, the individual 402 and the vehicle 410 trigger the inner presence sensor 116B (e.g., by breaking and unbreaking a triggering emission from the sensor) and the identification sensors 114 are activated. The individual 402 and the vehicle 410 are now within the sensing area 112, and the identification sensors 114 are activated. The identification sensors 114 detect the patron identification 404, the vehicle identification 416, and the item identification 414 within the sensing area 112. The system locates information associated with the individual 402, the vehicle 410 and the item 412. At this point, the item 412 and the vehicle 410 may not yet be assigned as being checked out to the individual 402, as the individual 402 may change his/her mind and return to the vending area to add, remove, or replace an item or equipment.

In FIG. 4C, the individual 402 triggers the outer presence sensor 116A and exits the sensing area 112. At this point, the system may assign the item 412 and the vehicle 410 as being checked out to the individual 402, and a record may be created in a system database. In some embodiments, the vehicle 410 may be of a length where both the inner presence sensor 116B and the outer presence sensor 116A are triggered at the same time. The system may not assign the vehicle 410 or any items 412 to the individual 402 until the outer presence sensor 116A is activated. In an example embodiment, the outer presence sensor 116A is a laser and is interrupted by the vehicle 410 when the vehicle is in the sensing area 112. The checkout record is created when the laser of the outer presence sensor 116A is no longer interrupted by the vehicle 410 after the vehicle has left the sensing area 112.

As shown in FIGS. 4A-4C, a checkout screen 406 may be provided. The checkout screen 406 may display checkout information 408 to show the individual 402 what he/she is checking out. The checkout screen 406 may be a display adjacent to the sensing area 112 or may be a display on a mobile device associated with the individual 402. The checkout information 408 may also be sent to third parties associated with the individual 402, such as a company the individual 402 works for. The checkout information 408 may be displayed while the individual 402, the vehicle 410 and the item 412 are in the sensing area 112 and/or after the individual 402, the vehicle 410, and the item 412 have exited the sensing area 112.

In some embodiments, the system may verify whether the individual 402 checking out the vehicle 410 or item 412 is properly certified or approved to use the vehicle 410 or item 412. The system database may store certification information associated with the individual 402, and when the individual 402 attempts to check out a vehicle 410 or an item 412 that he/she is not certified to use, the system may create an alert. An administrator may request additional information from the individual 402 based on the alert.

The process shown in FIGS. 4A-4C may, at a later time, be performed in reverse, with the individual 402 returning the previously checked out vehicle 410 and item 412. During a check-in procedure, when the individual 402, vehicle 410, and the item 412 are in the sensing area 112, the system may access the system records to determine whether the individual 402 has checked out vehicle 410 and item 412. In some embodiments, the individual 402 may return the vehicle 410 and item 412 on behalf of a coworker, and the system may recognize the check-in if the individual 407 and the coworker (who is on record as checking out the vehicle 410 and item 412) are associated in the system database. Two individuals may be associated in the system database if they both are recorded as working for the same company, for example.

In some embodiments, the system may monitor a number of times an item or equipment has been rented out and used, and periodically, an alert may be issued when an item or equipment which should be maintained is returned. For example, an all-terrain vehicle may be examined for mechanical issues after every five uses. Thus, when a patron returns the all-terrain vehicle and it is the fifth time the particular all-terrain vehicle has been used, an alert may be issued by the system to the owner of the all-terrain vehicle to perform maintenance on the particular all-terrain vehicle.

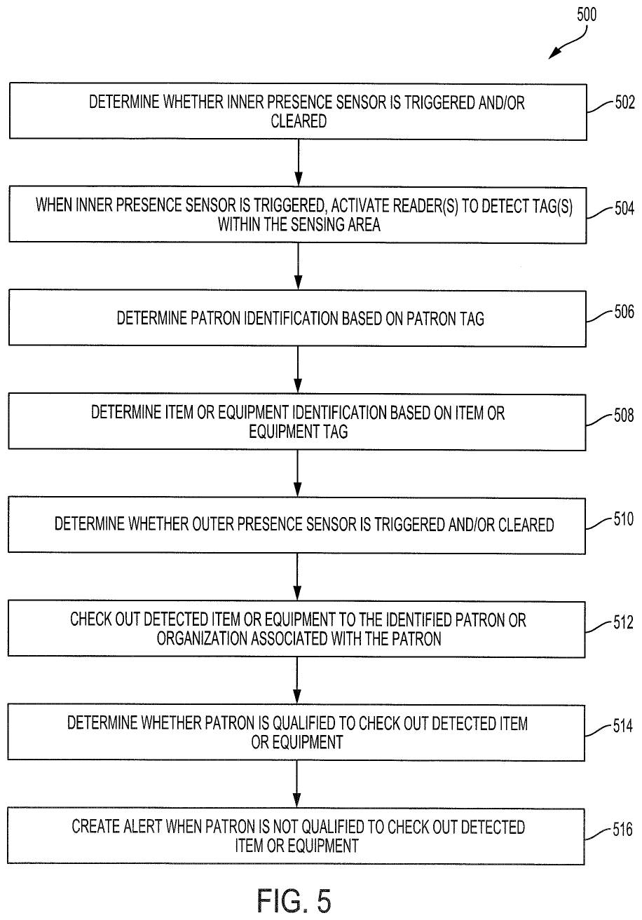

FIG. 5 is a flowchart of a check out process, according to embodiments of the invention. In addition to the components described herein, the system may also include an inventory management unit connected to the components described herein to perform the duties of the system. The inventory management unit may be implemented as one or more processors and memory configured to store instructions to be performed by the processor.

The system determines whether the inner presence sensor (e.g., inner presence sensor 116B) is triggered and/or cleared (step 502). In some embodiments, the inner presence sensor may be blocked, indicating that an individual or object is in proximity of the inner presence sensor, and the inner presence sensor may then be cleared, indicating that the individual or object is no longer in proximity of the inner presence sensor. As described herein, the process of blocking and clearing a sensor may be referred to as triggering the sensor. In some embodiments, the inner presence sensor detects when the patron has entered and transmits an indication to the inventory management unit that the patron has entered the sensing area.

When the inner presence sensor is triggered, the identification sensors (or readers) (e.g., identification sensors 114) are activated to detect patron or item identifications (or tags) within the sensing area (step 504). By not constantly being activated and detecting identifications in the sensing area, resources, such as computing power and electricity may be conserved. In some embodiments, the inventory management unit instructs the identification sensors to be activated when the inventory management unit receives the indication that the patron has entered the sensing area.

An identification of the patron present in the sensing area is determined based on the patron identification or patron tag (e.g., patron identification 304)(step 506). For example, the patron identification may indicate to the identification sensor that JBX222 is present in the sensing area, and a system database may store a table identifying JBX222 with James Smith. In some embodiments, the identification sensor provides a patron identifier to the inventory management unit, which accesses a database to determine the patron associated with the patron identifier.

An identification of the item or equipment present in the sensing area is determined based on the item or equipment identification or tag (e.g., item identification 414 or vehicle identification 416) (step 508). For example, the equipment identification may indicate to the identification sensor that LXQQ3000 is present in the sensing area, and the system database may store a table identifying LXQQ3000 as being a particular forklift. In some embodiments, the identification sensor provides an item identifier to the inventory management unit, which accesses a database to determine the item associated with the item identifier.

The system determines whether the outer presence sensor has been triggered and/or cleared (step 510). When the outer presence sensor has been triggered and/or cleared, the item or equipment detected in step 508 is checked out to the patron detected in step 506 and/or an organization associated with the patron (step 512). In some embodiments, the outer presence sensor detects when the patron has exited the sensing area and transmits an indication to the inventory management unit that the patron has exited the sensing area, and the inventory management unit modifies the database to indicate that the item has been checked out to the patron. In some embodiments, the database includes a table of items located in the vending area and an associated patron (if any) that the item is checked out to.

In some embodiments, the system determines whether the patron is qualified to check out the detected item or equipment (step 514). The qualification may be based on technical skill-based certifications, account standing status, membership status, association with a particular company or trade group, or by any other criteria. The qualifications of each registered patron may be stored in the system database, and the determination of whether the patron is qualified may be made by the inventory management unit.

When the patron is not qualified to check out the detected item or equipment, an alert may be generated (step 516). For example, if the patron is not certified to operate a forklift, or has a delinquent account balance, or is not associated with a particular company, the alert may be generated. The alert may be displayed on the display adjacent to the sensing area or may be pushed to a mobile device (e.g., smartphone, laptop, tablet, wearable device) to be displayed on a screen of the mobile device. In some embodiments, the inventory management unit instructs the display to display the alert, or the inventory management unit instructs a remote server to send the alert to an associated mobile device.

In some embodiments, when the patron cannot be identified in step 506 or when the items or equipment may not be identified in step 508, image data is obtained via a camera or other sensor proximate to the sensing area such that a patron, item, or equipment may be identified at a later time based on the image data. The patron and/or the items or equipment may not be identified if the identifications (or tags) were damaged or if the patron and/or items passed through the sensing area too quickly to be detected by the identification sensors. In some embodiments, speed control objects, such as speed bumps, may be located before and/or after the sensing area to limit a speed of a vehicle passing through the sensing area. If a patron identification is not read, the transaction may be assigned to a designated or default account so that it can be captured temporarily, and the record may be reconciled later based on a subsequent identification of the patron using image data from the camera or a voluntary identification from the patron.

In some embodiments, the identification sensors may be configured to detect multiple individuals inside the sensing area and detect, based on proximity and/or image data, which detected items are associated with which one of the multiple individuals in the sensing area. In some embodiments, a session or transaction may time-out independent of the detection of the presence sensors if the system determines an attempt to deviate from proper usage of the system occurred. In some embodiments, any of the sensors or cameras described herein may operate on a delay to better manage timing or sequence for visual capture for identification. In the reporting system, the images are associated with the transaction and are visible in a transaction report. All reporting developed is done so that it ensures utilization, return on assets, proper stock inventory levels of items or assets, as well as transactional discipline and capture.

In some embodiments, an additional sensor may verify that the patron and/or vehicle which checked out an item or equipment reached a particular destination. For example, in a goods fulfillment warehouse, multiple truck bays may be present and a forklift operator checking out one or more items may be confused as to which truck bay to go to, to drop off the one or more items, if the truck bays are not clearly marked. The system may include one or more additional sensors to detect whether the forklift operator ultimately went to the correct truck bay corresponding to the one or more items on the forklift. The system detects when the one or more items were checked out and also detects an identification associated with the particular forklift and/or the particular forklift operator. The system then detects whether the particular forklift and/or the particular forklift operator arrives at the truck bay corresponding to the one or more items via a sensor located proximate to the truck bay. The sensor located proximate to the truck bay is configured to detect the identification of the forklift and/or the forklift operator.

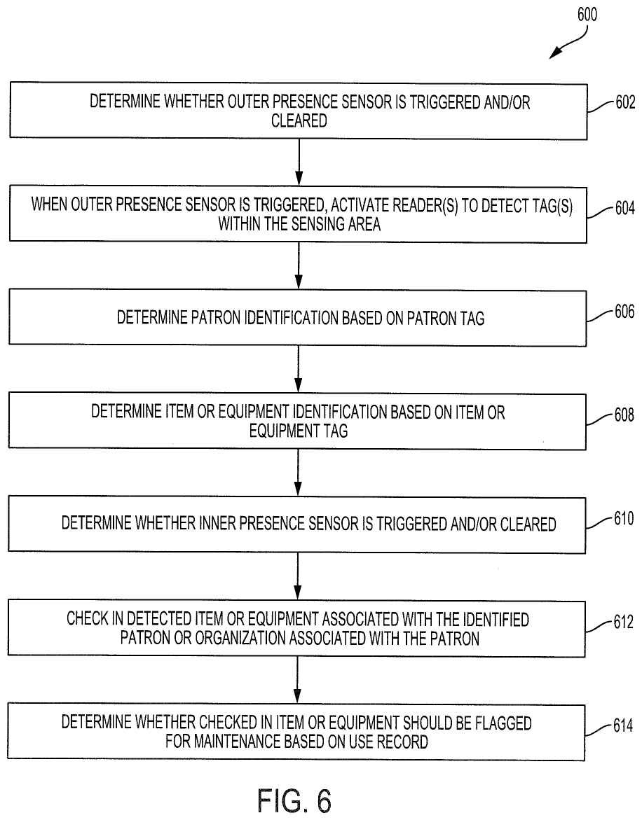

FIG. 6 is a flowchart of a check-in process, according to embodiments of the invention.

The system determines whether the outer presence sensor is triggered (step 602). In some embodiments, the outer presence sensor detects when the patron has entered and transmits an indication to the inventory management unit that the patron has entered the sensing area.

When the outer presence sensor is triggered, identification sensors (or readers) are activated to detect identifications (or tags) within the sensing area (step 604). In some embodiments, the inventory management unit instructs the identification sensors to be activated when the inventory management unit receives the indication that the patron has entered the sensing area.

A patron is identified based on a patron identification within the sensing area (step 606). In some embodiments, the identification sensor provides a patron identifier to the inventory management unit, which accesses a database to determine the patron associated with the patron identifier.

An item or equipment is also identified based on an item or equipment identification within the sensing area (step 608). In some embodiments, the identification sensor provides an item identifier to the inventory management unit, which accesses a database to determine the item associated with the item identifier.

In some embodiments, when the item or equipment that is identified in step 608 is not listed in the system database as being checked out, a record may be created of the occurrence, and image data from a camera or other sensor may be detected and saved to later reconcile the discrepancy in records.

The system determines whether the inner presence sensor is triggered (step 610). When the inner presence sensor is triggered, the item or equipment identified in step 608 is checked in and the system database no longer indicates that the item or equipment is checked out to the patron identified in step 606 (step 612). In some embodiments, the inner presence sensor detects when the patron has exited the sensing area and transmits an indication to the inventory management unit that the patron has exited the sensing area, and the inventory management unit modifies the database to indicate that the item has been checked in.

In some embodiments, the inventory management unit and the system database tracks a number of times an item or equipment has been checked out and checked in, and an alert may be created when it is time for the item or equipment to be serviced (step 614).

In some embodiments, a patron may reserve an item or equipment online and may check out the reserved item or equipment, as described herein. In some embodiments, when an item or equipment is reserved, an alert is created when another patron attempts to check out the reserved item or equipment.

In some embodiments, multiple different item and/or equipment owners may store their items and/or equipment in the vending area to be rented by patrons, and the inventory management unit and the database are configured to be able to maintain a record of the statuses of the items in the vending area owned by the multiple different owners. The various owners may have different requirements for their items, and when a requirement is not met by a particular patron, an alert may be generated. For example, Owner A may specify that only those who own a licensed business may rent Owner A's items, but Owner B may have no such requirement. When a patron who does not own his or her own business attempts to check out an item owned by Owner A, the patron may be refused the ability to check it out, but when the same patron attempts to check out an item owned by Owner B, the patron may be allowed to check it out.

In some embodiments, the system is capable of managing consumable items with an expiration date. These items may not be capable of being returned (or checked in). If a return would be attempted during the transaction, it would be noted, however only for tracking purposes and not for actual consumption modification.

The sensors used by the system described herein are of sufficient sensitivity and speed to detect identification of the patron, items, or equipment even if the patron, items, or equipment is moving rapidly through the sensing area. Further, the patron does not have to stop to show identification or to pay for the rental of the items or equipment, and speed of checking out and checking in equipment may be increased. The free flow of equipment check out and check-in encourages individuals to patronize the establishment using the system described herein.

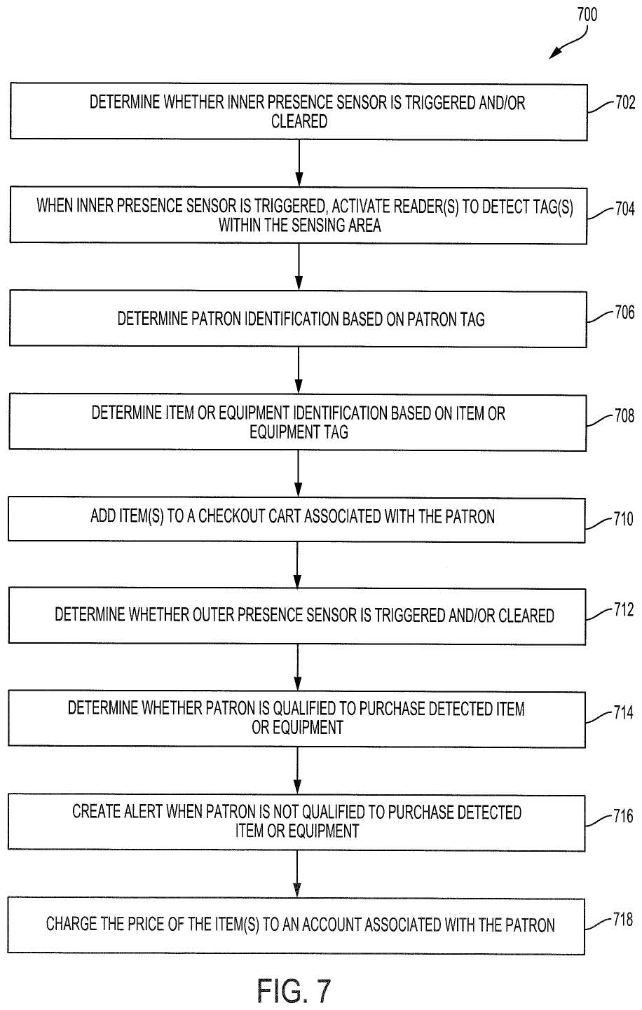

While checkout and check-in of rental equipment has been discussed herein, the system may also be used for automated checkout of retail goods, including items and equipment, as described herein. FIG. 7 illustrates a flowchart of a checkout process of retail goods, according to embodiments of the invention.

The system determines whether the inner presence sensor (e.g., inner presence sensor 116B) is triggered and/or cleared (step 702). In some embodiments, the inner presence sensor detects when the patron has entered and transmits an indication to the inventory management unit that the patron has entered the sensing area.

When the inner presence sensor is triggered, the identification sensors (or readers) (e.g., identification sensors 114) are activated to detect patron or item identifications (or tags) within the sensing area (step 704). In some embodiments, the inventory management unit instructs the identification sensors to be activated when the inventory management unit receives the indication that the patron has entered the sensing area.

An identification of the patron present in the sensing area is determined based on the patron identification or patron tag (e.g., patron identification 304)(step 706). In some embodiments, the identification sensor provides a patron identifier to the inventory management unit, which accesses a database to determine the patron associated with the patron identifier.

An identification of the item or equipment present in the sensing area is determined based on the item or equipment identification or tag (e.g., item identification 414 or vehicle identification 416) (step 708). In some embodiments, the identification sensor provides an item identifier to the inventory management unit, which accesses a database to determine the item associated with the item identifier.

When the patron and the item are detected as being within the sensing area at the same time, based on the triggering of the inner presence sensor, the item may be added to a checkout cart for this current transaction (step 710). The inventory management unit may be configured to generate a temporary checkout cart for the patron's transaction, and populate the cart with the item(s) detected within the sensing area.

The system determines whether the outer presence sensor has been triggered and/or cleared (step 712). In some embodiments, the outer presence sensor detects when the patron has exited the sensing area and transmits an indication to the inventory management unit that the patron has exited the sensing area.

In some embodiments, the system determines whether the patron is qualified to purchase the detected item or equipment (step 714). The qualification may be based on technical skill-based certifications, account standing status, membership status, association with a particular company or trade group, age, or by any other criteria. The qualifications of each registered patron may be stored in the system database, and the determination of whether the patron is qualified may be made by the inventory management unit.

When the patron is not qualified to purchase the detected item or equipment, an alert may be generated (step 716). The alert may be displayed on the display adjacent to the sensing area or may be pushed to a mobile device (e.g., smartphone, laptop, tablet, wearable device) to be displayed on a screen of the mobile device. In some embodiments, the inventory management unit instructs the display to display the alert, or the inventory management unit instructs a remote server to send the alert to an associated mobile device. In some embodiments, a barrier is lowered such that the patron's path is blocked.

When the outer presence sensor has been triggered and/or cleared, and when the patron is permitted to purchase the item(s) in the checkout cart, the item(s) detected in step 708 and listed in the checkout cart are charged to the patron (step 718). More specifically, the total cost of the item(s) along with any applicable taxes and other fees are charged to the patron. The inventory management unit may have a stored payment account associated with the patron. The stored payment account may be a debit account, stored credit card information, stored bank account information, or a virtual wallet representing a value of currency (e.g., dollars, pesos, cryptocurrency). The inventory management unit modifies the database to indicate that the item has been purchased by the patron, and the inventory management unit also processes the payment for the cost of the item.

In some embodiments, steps 714 and 716 are optional, and no check is performed on the patron's qualifications to purchase the items in the checkout cart.

In some embodiments, when the patron cannot be identified in step 706 or when the items or equipment may not be identified in step 708, image data is obtained via a camera or other sensor proximate to the sensing area such that a patron, item, or equipment may be identified at a later time based on the image data. If a patron identification is not read, the transaction may be assigned to a designated or default account so that it can be captured temporarily, and the record may be reconciled later based on a subsequent identification of the patron using image data from the camera or a voluntary identification from the patron.

The system described herein may further be used in a context of inventory management in a distribution or warehouse facility. A gateway (e.g., gateway 106 or 206) may be located adjacent to or in front of an opening of a distribution vehicle(s), such as a delivery truck, which receives one or more items to be distributed. The distribution center may have a warehouse, which is similar to the secure vending area of FIG. 1. A particular item (e.g., item 124) may be removed from the distribution or warehouse facility. The item may be removed by an individual (e.g., individual 302) or by a fulfillment vehicle (e.g., vehicle 410). The fulfillment vehicle may be a hand truck pushed by an individual or a self-propelled vehicle.

The individual or the fulfillment vehicle may have an identification (e.g., vehicle identification 416 or patron identification 404), such that when the individual/fulfilment vehicle and the items pass through the gateway, the inventory management unit (e.g., inventory management unit 240) may be able to verify the items being removed from the warehouse and identify what is moving the items (e.g., a particular individual or a particular vehicle).

In some embodiments, there is a single gateway (e.g., gateway 106 or 206) at an opening to the distribution or warehouse facility to verify the items being removed from the distribution or warehouse facility by a fulfillment vehicle, and there are individual sensors at each of the ports to the distribution vehicles to verify that the correct individual or vehicle reached the correct corresponding distribution vehicle.

When the items are removed from the distribution or warehouse facility and are located within the sensing area of the gateway, the presence of the items and the individual within the sensing area may be detected by the presence sensors (e.g., presence sensors 116 or 216) and the items within the sensing area may be detected by identification sensors (e.g., identification sensors 114 or 214). The individual or fulfillment vehicle carrying the items is also identified, and the items and individual or fulfillment vehicle exit the sensing area of the gateway.

The individual or fulfillment vehicle reaches the port where the items are to be delivered to a distribution vehicle. At the port, there may be a second sensor connected to the inventory management system and configured to detect the individual or fulfillment vehicle carrying the items, to ensure that the individual or fulfillment vehicles delivered the items to the correct port. That is, the gateway at the opening of the distribution or warehouse facility is configured to detect the correct items were removed from the distribution or warehouse facility, and the second sensor at the port is configured to detect that the items were sent to the correct distribution vehicle. The second sensor may be any of the sensors described herein, including a camera or an RFID antenna.

For example, a forklift may have an identifier of FL444, and it may be assigned to move a first item having an item identification DD112 and a second item having an item identification BB092 to the delivery truck at the fifth loading dock. The inventory management unit may be provided with inventory data indicating that FL444 will be moving DD112 and BB092 to the fifth loading dock. When the forklift arrives at the gateway, it triggers an outer presence sensor of the gateway, activating the identification sensors of the gateway. The identification sensors detect the presence of forklift FL444 and items DD112 and BB092 in the sensing area. The inventory management unit is provided this information, and determines the corresponding port the items should be delivered to, which is the fifth loading dock.

The forklift arrives at the fifth loading dock, and a sensor at the fifth loading dock detects the forklift FL444 has arrived at the correct loading dock. No alert may be generated, or a confirmatory display or sound may be provided. Had the forklift gone to the second loading dock, the sensor at the second loading dock would have detected that the forklift had gone to the wrong loading dock, and an alert may be provided, such as a sound or display.

In some embodiments, there are multiple gateways at each port to each distribution vehicle. These gateways may also include a pair of presence sensors (e.g., presence sensors 116 or 216) configured to detect when a fulfillment vehicle (not the distribution vehicle), such as a forklift, or an individual carrying the items, is in range of the identification sensors, and may trigger the identification sensors to detect the items in the sensing area (e.g., sensing area 112 or 212) defined by the gateway.

The inventory management unit may be provided with a list of items that a particular fulfillment vehicle or individual is moving to a particular distribution vehicle. When the fulfillment vehicle or individual is in the sensing area with the items to be moved to the distribution vehicle, the inventory management unit may be able to determine whether the correct items are being moved to the distribution vehicle.

For example, a forklift may have an identifier of FL444, and it may be assigned to move a first item having an item identification DD112 and a second item having an item identification BB092 to the fifth loading dock having Gateway 5 adjacent to it. The inventory management unit may be provided with inventory data indicating that FL444 will be moving DD112 and BB092 to the fifth loading dock. When the forklift arrives at the fifth loading dock, it triggers an outer presence sensor of Gateway 5, activating the identification sensors of Gateway 5. The identification sensors detect the presence of forklift FL444 and items DD112 and BB092. The inventory management unit is provided this information, and determines whether it matches the inventory data previously provided. As it matches, either no alert may be provided or a confirming alert may be provided.

If the forklift had gone to the second loading dock, for example, and gone through Gateway 2, the inventory management unit would detect the mismatch of the previously provided inventory data and the detected items passing through Gateway 2, and an alert may be provided. In addition, if the forklift had also carried a third item through Gateway 5 in addition to the first and second item, the inventory management unit would detect the mismatch of the previously provided inventory data and the detected items passing through Gateway 5, and an alert may be provided.

The initial inventory of items that are to be moved from the warehouse to the vehicle may be identified to the inventory management unit via a computing device communicatively coupled to the inventory management unit and stored in a system database.

All aspects of the systems described herein with respect to FIGS. 1, 2A-2B, 3A-3C, and 4A-4C has an analog in the application of inventory management in a distribution facility or retail applications.

In some embodiments, the system described herein may be configured to simply keep a running list of the items being moved from the distribution or warehouse facility to each distribution vehicle, and the items moved to the distribution vehicles are not checked against a checklist or manifest. However, a master inventory stored on a system database may be updated.

The system described herein may also be used to account for items being received by distribution vehicles. When the distribution vehicle is being unloaded, the systems described herein may be used to verify whether the items received from the distribution vehicle match a checklist or manifest.

For example, when there is a single gateway at the entrance to the distribution or warehouse facility and there is a sensor at each port to the incoming distribution vehicles, the port sensor detects a fulfillment vehicle or individual retrieving the one or more items from the incoming distribution vehicles and when the fulfillment vehicle reaches the single gateway, the single gateway detects the fulfillment vehicle or individual carrying the one or more items, and verifies that the items came from the correct distribution vehicle, based on a checklist or manifest stored in the system database.

In another example, when there is a gateway at each port of the incoming distribution vehicles, the port gateway detects a fulfillment vehicle or individual retrieving the one or more items from the incoming distribution vehicle and as the fulfillment vehicle or individual passes through the port gateway, the port gateway verifies that the items came from the correct distribution vehicle, based on a checklist or manifest stored in the system database.

In some embodiments, the system described herein may be configured to simply keep a running list of the items being received by the distribution or warehouse facility from each distribution vehicle, and the items moved from the distribution vehicles are not checked against a checklist or manifest. However, a master inventory stored on a system database may be updated.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for checking out an item, the system comprising:
a gateway defining a sensing area and separating an outside area and an inside area for storing the item, the gateway having:
one or more presence sensors configured to detect when a patron and the item have entered the sensing area from the inside area, and when the patron and the item have left the sensing area to the outside area, and
one or more identification sensors configured to detect a patron identification associated with the patron and an item identification associated with the item when the patron and the item are within the sensing area;
an inventory management unit connected to the gateway and configured to:
identify the patron based on the patron identification,
identify the item based on the item identification, and
update a database when the patron and the item have left the sensing area to the outside area to indicate that the patron has checked out the item.

2. The system of claim 1, wherein the one or more presence sensors include an outside presence sensor located proximal to the outside area and an inner presence sensor located proximal to the inside area, and the one or more presence sensors are configured to detect when the patron moves from the inside area, to the sensing area, and to the outside area based on a triggering sequence of the inner presence sensor and the outer presence sensor.

3. The system of claim 1, wherein the one or more presence sensors are at least one of a photoelectric sensor, a motion sensor, a camera, a heat sensor, or a laser sensor.

4. The system of claim 1, wherein the one or more identification sensors are at least one of an RFID antenna, a Bluetooth antenna, or a Wi-Fi antenna.

5. The system of claim 1, wherein the gateway includes at least one vertical structure and at least one horizontal structure connected to the at least one vertical structure, and
wherein the one or more presence sensors are located on the at least one vertical structure and the one or more identification sensors are located on the at least one horizontal structure.

6. The system of claim 1, further comprising a camera located proximate to the sensing area and configured to detect image data, and
wherein the inventory management unit is configured to store image data of the patron and the item when the patron and the item are within the sensing area, when the inventory management unit is unable to identify the patron.

7. The system of claim 1, further comprising a camera located proximate to the sensing area and configured to detect image data, and
wherein the inventory management unit is configured to store image data of the patron and the item when the patron and the item are within the sensing area and the inventory management unit is unable to identify the item.

8. The system of claim 1, further comprising a checkout display configured to display checkout information associated with the item and the patron.

9. A system for checking in an item, the system comprising:
a gateway defining a sensing area and separating an outside area and an inside area for storing the item, the gateway having:
one or more presence sensors configured to detect when a patron and the item have entered the sensing area from the outside area, and when the patron and the item have left the sensing area to the inside area, and
one or more sensors configured to detect a patron identification associated with the patron and an item identification associated with the item when the patron and the item are within the sensing area;
an inventory management unit connected to the gateway and configured to:
identify the patron based on the patron identification,
identify the item based on the item identification, and
update a database when the patron and the item have left the sensing area to the inside area to indicate that the patron has checked in the item.

10. The system of claim 9, wherein the one or more presence sensors include an outside presence sensor located proximal to the outside area and an inner presence sensor located proximal to the inside area, and the one or more presence sensors are configured to detect when the patron moves from the outside area, to the sensing area, and to the inside area based on a triggering sequence of the inner presence sensor and the outer presence sensor.

11. The system of claim 9, wherein the one or more presence sensors are at least one of a photoelectric sensor, a motion sensor, a camera, a heat sensor, or a laser sensor.

12. The system of claim 9, wherein the one or more identification sensors are at least one of an RFID antenna, a Bluetooth antenna, or a Wi-Fi antenna.

13. The system of claim 9, wherein the gateway includes at least one vertical structure and at least one horizontal structure connected to the at least one vertical structure, and
wherein the one or more presence sensors are located on the at least one vertical structure and the one or more identification sensors are located on the at least one horizontal structure.

14. The system of claim 9, further comprising a camera located proximate to the sensing area and configured to detect image data, and
wherein the inventory management unit is configured to store image data of the patron and the item when the patron and the item are within the sensing area and the inventory management unit is unable to identify the patron.

15. The system of claim 9, further comprising a camera located proximate to the sensing area and configured to detect image data, and
wherein the inventory management unit is configured to store image data of the patron and the item when the patron and the item are within the sensing area, when the inventory management unit is unable to identify the item.

16. The system of claim 9, further comprising a camera located proximate to the sensing area and configured to detect image data, and
wherein the inventory management unit is configured to store image data of the patron and the item when the patron and the item are within the sensing area, when the database indicates that the item had not been checked out.

17. A method for managing a status of an item using a gateway defining a sensing area and separating an outside area and an inside area for storing the item, the method comprising:
detecting, by one or more presence sensors, when a patron and the item have entered the sensing area from the inside area;
detecting, by one or more identification sensors, a patron identification associated with the patron and an item identification associated with the item when the patron and the item are within the sensing area;
identifying, by an inventory management unit, the patron based on the patron identification;
identifying, by the inventory management unit, the item based on the item identification;
detecting, by the one or more presence sensors, when the patron and the item have left the sensing area to the outside area; and
updating, by the inventory management unit, a database when the patron and the item have left the sensing area to the outside area to indicate that the patron has checked out the item.

18. The method of claim 17, further comprising:
detecting, by the one or more presence sensors, when the patron and the item have entered the sensing area from the outside area;
detecting, by the one or more identification sensors, the patron identification associated with the patron and the item identification associated with the item when the patron and the item are within the sensing area;
identifying, by the inventory management unit, the patron based on the patron identification;
identifying, by the inventory management unit, the item based on the item identification;
detecting, by the one or more presence sensors, when the patron and the item have left the sensing area to the inside area; and
updating, by the inventory management unit, the database when the patron and the item have left the sensing area to the inside area to indicate that the patron has checked in the item.

19. The method of claim 17, further comprising detecting, by a camera, image data of the patron and the item within the sensing area when the inventory management unit is unable to identify the patron or the item.

20. The method of claim 17, further comprising displaying, by a checkout display, checkout information associated with the item and the patron.
